(19) United States
(12) Patent Application Publication
(10) Pub. No.: US 2007/0143250 A1
(43) Pub. Date: Jun. 21, 2007

(54) Adaptable database system

(75) Inventor: Robert Zigon, Carmel, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Beckman Coulter, Inc., Fullerton, CA (US)

(21) Appl. No.: 11/312,014

(22) Filed: Dec. 20, 2005

(51) Int. Cl. G06F 17/30

(52) U.S. Cl. 707/2

(57) ABSTRACT

An adaptable relational database system comprises a database schema having relational integrity, wherein the database schema includes a plurality of entities associated with a plurality of attributes. The plurality of attributes in the database may be varied such that the database includes a first set of attributes associated with a first time and a second set of attributes associated with a second time. The second set of attributes includes at least one attribute that is not included in the first set of attributes. The relational integrity of the database is maintained as the plurality of attributes in the database is varied. In one embodiment, the relational database is displayed in rectangular/table format, including a display of the first set of attributes, the second set of attributes and data associated with the first set of attributes and the second set of attributes.

### BACKGROUND

This invention relates to the field of databases. In particular, this invention relates to adaptable databases having referential integrity.

Data abounds in the modern world. The accumulation and interpretation of data is extremely important to businesses, governments, and other organizations. Human resource departments compile data concerning employees. Accounting departments compile information concerning product orders. Research and development departments compile information concerning new products and systems.

Databases, and particularly relational databases, are the primary tool used to organize and manage large quantities of data. Databases are collections of information organized in such a way that a computer program can quickly select desired pieces of data within the collection. It may generally be said that a relational database is a database that at least exhibits referential integrity. Referential integrity is generally a system of rules ensuring that relationships between rows in related tables of a database are valid and that related data is not accidentally deleted or changed. When referential integrity is enforced in a database, the following rules are observed: (i) a value cannot be entered in the foreign key column of a table if that value does not exist in the primary key column of a related table; (ii) a row cannot be deleted from a primary key table if rows matching it exist in a related table; and (iii) a primary key value in a primary key table cannot be changed if the row with the primary key value has related rows.

Relational databases are typically designed by first creating a logical schema. The logical schema comprises a logical diagram of multiple entities, with each entity representing a set of logically related attributes within the database. The logical diagram is then translated into a physical diagram with each logical entity represented by one or more physical tables of data in the physical diagram.

Each entity of the logical schema is defined by a plurality of attributes. An attribute is a characteristic of an entity and attributes have values. In a given table describing an entity, each row typically provides information about a specific record or instance of the entity, and each column typically represents an attribute related to the entity. The structure of the relational database allows selected data to be easily presented to users of the database in rectangular form (i.e., a table with data existing in some form in every row and every column, the data potentially including a null value, zero value or other default value, etc.).

Once the logical structure of a database is established with multiple entities having multiple attributes, and once the physical database is created, the physical database may be populated with data. The data population process typically occurs over time, with new data being collected and added to the database periodically. For example, a human resources department may only need to update its database when a new employee is hired or an existing employee departs. On the other hand, a research and development department of a pharmaceutical company may add new data to its database several times a day.

When a relational database is updated, the user of the relational database may wish to add additional attributes to an entity. One common example of this is in the bio-research/chemical laboratory setting where numerous variables may contribute to eventual experimental results. In this setting, after the scientist views data related to a first test, he or she may find that it would be advantageous to obtain additional information in subsequent tests. For example, if data related to a solvent temperature was not taken during a first trial run, the scientist may find that he or she would like to have this information listed as an attribute in the database for subsequent runs. Of course, other examples exist for most database systems. A human resources department may find that it would be helpful for their database to also include a years of service attribute to an employee database. Similarly, an accounting department may find that it would be helpful to add a second customer contact attribute to an accounts payable database.

In addition to the adding attributes and/or entities, it should also be recognized that the deletion of attributes or entities may be desirable in some situations. For example, the users of a product catalog database may recognize that a cell phone attribute is not worthwhile since very few customers are willing to distribute their cell phone numbers and even when the numbers are obtained from customers the company does not contact customers on their cell phones.

Accordingly, adaptable relational databases are desirable wherein attributes may be added to or removed from a database over time to meet the changing needs of the database users.

In prior art adaptable relational databases, when an attribute is added to the database, the attribute is added for all records in the entity. If previous records exist where a value for the attribute was not recorded, or is otherwise unknown, a null value or a default value is entered for that attribute in the record. When the data from the database is displayed in tabular form, a blank space is typically shown in the row to indicate a null value for that attribute in the record.

The aforementioned method of updating relational databases has several problems. First, as attributes are added to the database, the size of the database grows unnecessarily large as the new attribute must be added to previously existing records, and a null value must be entered in these previously existing records as the attribute value. The resulting increased size of the database not only takes up additional storage space (e.g., disk space), but also slows the speed of data retrieval from the database because each resulting row is larger than it needs to be.

A second problem with updating a relational database by adding a new attribute to previously existing records that did not include the attribute, is that the database does not reflect the reality of the data gathering process. In particular, the addition of a new attribute to a previously existing record suggests that the attribute was actually considered at the time the data was taken, but was not recorded for some unknown reason. This misrepresentation of reality may lead to incorrect conclusions. For example, consider a research and development database that includes various attributes associated with laboratory experiments. After numerous experiments are conducted, it is determined that a new attribute should be added for laboratory temperature. When this new attribute is added, a null value appears for old records associated with that attribute. After some time, the data is viewed by a new user who notes that the laboratory temperature is unknown (“null”) from many of the older database entries. In this situation, the person viewing the older data may not recognize that the laboratory temperature was not even considered for these older database entries, and may make an incorrect assumption concerning the null value shown in the table for the older database entries. For example, the person viewing the data could incorrectly assume that the laboratory temperature is unknown because the laboratory technician conducting the experiment was sloppy in his recordkeeping and failed to record the temperature. This assumption would not reflect the reality of the situation, which is that the laboratory technician was not even asked to consider the laboratory temperature.

Accordingly, it would be advantageous to provide an adaptable relational database wherein the presence of attributes better reflects the reality of the data gathering process. Furthermore, it would be advantageous to provide an adaptable relational database wherein the addition of attributes consumes less space in the database.

### SUMMARY

An adaptable database is disclosed herein having a database schema with referential integrity. The database schema defines a plurality of entities and a plurality of attributes.

The adaptable relational database comprises at least one entity table comprising a plurality of rows, the plurality of rows of the at least one entity table including a first row associated with a first time and a second row associated with a second time that is different from the first time. Entity attributes may also be provided in the rows of the at least one entity table.

The adaptable relational database further comprises at least one entity attribute table comprising a plurality of attribute-name/attribute-value pairs. In particular, the entity attribute table comprises a plurality of rows, with each row including a foreign key value and at least one attribute name and at least one attribute value associated with the attribute name. The plurality of rows of the entity attribute table comprise a first set of rows having a first common foreign key and a second set of rows having a second common foreign key. Each row of the first set of rows of the entity attribute table is associated with the first row of the entity table, and each row of the second set of rows of the entity attribute table is associated with the second row of the entity table. The number of rows in the first set of rows in the entity attribute table is different from the number of rows in the second set of rows in the entity attribute table. In this manner, different numbers of attributes are associated with different rows of the entity table. As a result, a particular attribute that exists in association with one row of the entity table may not exist for a different row of the entity table.

A clustered index is provided on the foreign key of the entity attribute table. The clustered index guarantees that a given set of attributes are physically contiguous on the hard disk that stores the database. The clustered index leads to significant performance benefits for the database.

The data in the entity attributes table may be pivoted such that the data is provided in a rectangular display table. The display table includes a plurality of column headings, with the attribute names from the first set of rows and the second set of rows provided as the plurality of column headings.

The relational database described herein may be used to perform a method of storing data in a relational database. The method comprises populating the database with data associated with a plurality of attributes. Thereafter, the plurality of attributes in the database are varied over time such that the database includes a first set of attributes associated with a first time and a second set of attributes associated with a second time. The second set of attributes includes at least one attribute that is not included in the first set of attributes. The relational integrity of the relational database is maintained as the plurality of attributes in the database is varied.

The method described herein may also comprise the step of displaying the relational database in a rectangular format. The rectangular format includes display of the first set of attributes, the second set of attributes and data associated with the first set of attributes and the second set of attributes. The database display includes a first portion of the display showing the first set of attributes and data associated therewith, and a second portion of the display showing the second set of attributes and data associated therewith. The first portion of the display shows a null value for the at least one attribute that is not included in the first set of attributes.

### BRIEF DESCRIPTION OF THE DRAWINGS

FIG. 1 shows a logical diagram for an exemplary database schema;

FIG. 2 shows a tabular representation of an exemplary collection of data stored in a database having the logical diagram of FIG. 1;

FIG. 3 shows a physical diagram of tables used to manage the logical diagram of FIG. 1;

FIG. 4 shows a WELL table derived from the data of FIG. 2;

FIG. 5 shows a WELL_ATTRIBUTE table derived from the data of FIG. 2 and related to the WELL table of FIG. 4;

FIG. 6 shows the data from the tables of FIG. 4 and FIG. 5 in rectangular format;

FIG. 7 shows an exemplary page of a user interface for an adaptable database system;

FIG. 8 shows an exemplary page of a report generator for the database system of FIG. 7; and

FIG. 9 shows an exemplary report resulting from the report generator of FIG. 8.

### DESCRIPTION

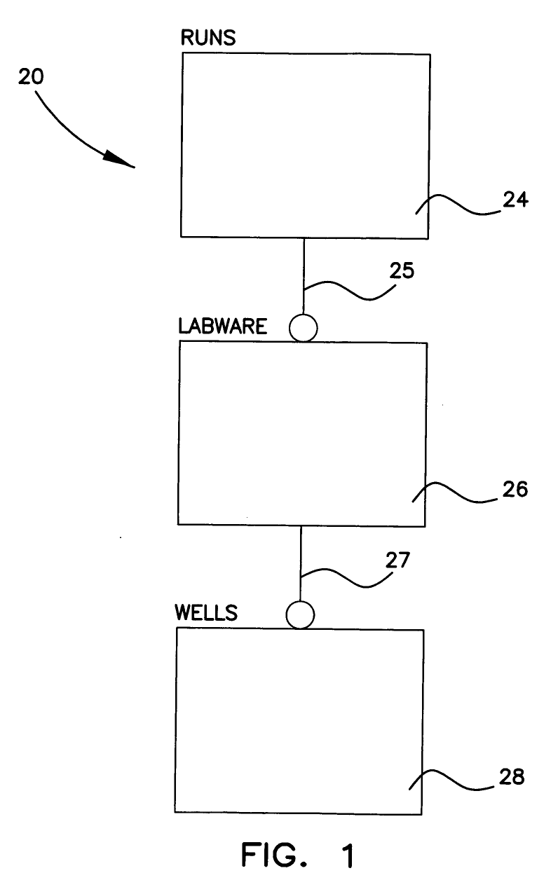

With reference to FIG. 1, a logical diagram of a database schema 20 is shown for an exemplary database in the field of life-sciences. The database schema 20 is designed to manage data collected from various laboratory experiments. In the exemplary experimental process, it is anticipated that multiple experimental runs will occur. Each run will include multiple labware (e.g., micro titer plates, a.k.a., microplates). Each piece of labware will include multiple wells, with each well configured to receive an experimental compound or other experimental material. Testing conducted on the contents in each well will yield experimental results related to the contents in each well.

Accordingly, as shown in FIG. 1, the logical schema 20 for the database is comprised of three entities, including a RUNS entity, a LABWARE entity, and a WELLS entity. Each logical entity is represented by one or more physical tables in the database, including at least one RUNS table 24, at least one LABWARE table 26, and at least one WELLS table 28. As noted by referential line and circle 25 of FIG. 1, each experimental run from the RUNS table 24 is associated with multiple labware from the at least one LABWARE table 26. In addition, as noted by referential line 27 of FIG. 1, each piece of labware from the LABWARE table 26 is associated with multiple wells from the at least one WELLS table 28.

Example Data From Experimental Bio-Medical Data Gathering Process

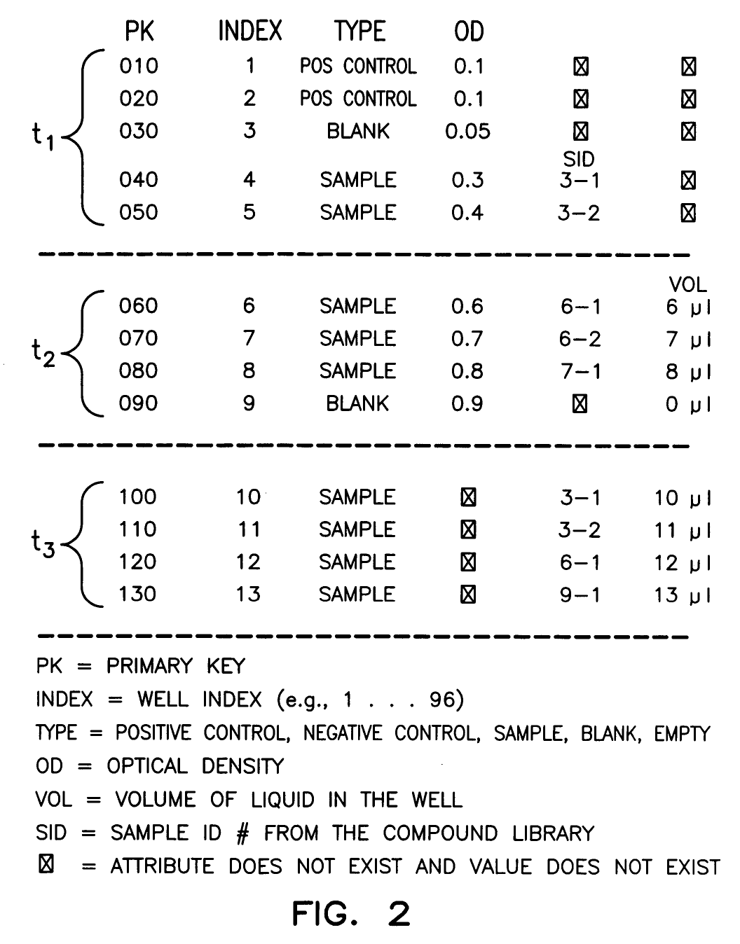

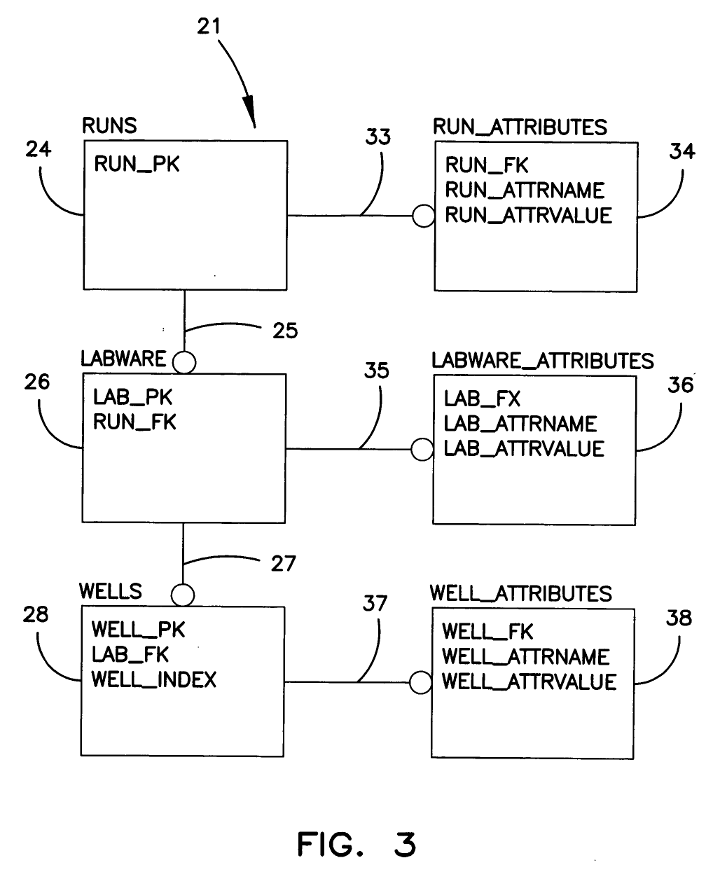

With reference now to FIG. 2, an exemplary set of data is shown resembling the type of data that may be collected from an experimental biomedical process. This exemplary set of data is to be used in populating a database having the database schema of FIG. 1. More particularly, this exemplary set of data is a representation of data used to populate the WELLS table 28 and WELL_ATTRIBUTES table 38 of FIG. 3, as will be explained in further detail below.

The exemplary data set of FIG. 2 is shown in a tabular-type format, but it is not in traditional form. In particular, the data of FIG. 2 includes brackets on the left side to indicate rows of data associated with different times. In addition, every column does not include a column heading at the top of the column. The reasons for this format will be explained in the following paragraphs, with the understanding that the data presented in FIG. 2 is provided as graphical display of an exemplary set of data collected during an experimental process, and not in a format for distributing to the user of a database.

Each row of the exemplary data set of FIG. 2 provides a particular “record” or collection of data associated with a particular well from a particular piece of labware from a particular experimental run. The columns of the exemplary table of FIG. 2 provide the attributes associated with each row or “record”. A specific data entry at the intersection of a row and column provides the value for the attribute in that row. These values may be numerical values, text strings, combinations of text and numbers, nulls or any other value entries as are known in the art.

Brackets are provided along the left side of the graphical table of FIG. 2 to indicate three distinct timeframes during which data was collected. In particular, the brackets show that five rows of data are associated with a first time t₁, four rows of data are associated with a second time t₂, and four rows of data are associated with a third time t₃. Although no time attribute is provided in FIG. 2 to show a particular time in which the data for a particular row was obtained, one of skill in the art will recognize that a time attribute and associated value could be added to one or more rows of FIG. 2 to identify a specific or general time when the data in the row was collected or otherwise obtained. For example, a “timestamp” attribute could be added to each row in FIG. 2 along with an actual time value for the attribute. An exemplary format for such a time value may be hour:minute:day:month:year (e.g., 14:45:30:12:2005).

Whether or not a time attribute and value is collected for the data of a particular row, it can be said that the data in the rows of a collection of data, such as that of FIG. 2, are “associated” with a particular time. In particular, as used herein, the concept of data “associated with a particular time” refers to data obtained during the particular time or time period, or otherwise related to the particular time period. For example, the values for a row of data in a given table can be said to be “associated” with the time the data values for the row were obtained, regardless of whether a timestamp or other time-related attribute is included in the row. Accordingly, the rows of data in FIG. 2 do not show a time attribute, but different time periods are associated with the different rows as noted by brackets t₁, t₂, and t₃. As will be explained in further detail below, the attributes collected during one time period may vary from the attributes collected during a different time period. Furthermore, different events may trigger the ending of one time period and the beginning of a subsequent contiguous time period.

With continued reference to FIG. 2, each row of data includes values for a primary key (PK) and a plurality of attributes including, a well index attribute (INDEX) and a well type attribute (TYPE). The PK value is a unique value that may be used to identify a particular row of the table. Therefore, no other row in the table may have the same value for its primary key. The INDEX value is a numerical value that represents a particular well from the labware. For example, for a ninety-six well microplate, the index will range from one to ninety-six. The TYPE value describes the purpose of the well within the assay. The values associated with the TYPE attribute are text strings that describe the contents of the well. For example, the TYPE value for the contents of a particular well may include the text strings “positive control”, “negative control”, “blank”, “empty”, or “sample”.

Data Collected From Time T₁

During time t₁ of FIG. 2, the operator of an automated laboratory device instructed the device to determine an optical density value for five wells. These five wells are associated with primary keys 010, 020, 030, 040 and 050 in the table of FIG. 2. An optical density attribute (OD) value was recorded in association with each of the primary keys. As shown in the table, these OD values were measured as 0.1, 0.1, 0.05, 0.3 and 0.4 absorbance units, respectively.

Other than values for INDEX, TYPE and OD, the operator did not record any additional information associated with PKs 010, 020, and 030, during time t₁. However, the operator did record additional information associated with PKs 040 and 050. In particular, the wells associated with PKs 040 and 050 included contents of “sample” TYPE, and sample identification numbers were recorded for these samples. These sample identification numbers typically correspond to compounds from a component library and associated database. Accordingly, an additional sample identification number attribute (SID) value is listed for the rows associated with primary keys 040 and 050 in the table of FIG. 2. The SID value in the row associated with primary key 040 is “3-1” and the SID value in the row associated with primary key 050 is “3-2”.

The SID values are used by the scientist to determine the specific compounds retained in the well during the experiment. These SID values are only associated with rows having a TYPE value of “sample”, and do not apply to other rows having TYPE values such as “positive control”, “negative control”, “blank” or “empty”. The reason for this is that the well contents associated with these other TYPE values are not samples and do not have an associated SID. Therefore, if a row has a TYPE value different than “sample”, the database does not record any value associated with the SID attribute for such a row. Furthermore, it should be noted that database does not even indicate that the SID attribute exists for those rows having a TYPE value different than “sample”. In particular, the database does not record a null (or “unknown”) value for the SID attribute in these rows. Instead, the SID attribute does not even exist for these rows having a TYPE value different than “sample”. Accordingly, the graphic of FIG. 2 does not display a SID heading at the top of the column that is otherwise used for SID values, as primary keys 010, 020, and 030 are not even associated with the SID attribute. In place of a SID value for primary keys 010, 020, and 030, an icon including a box with an x inside is shown to indicate that the attribute does not exist, and a value for the attribute does not exist for that row. Hereinafter, the term “non-existent icon” will be used to describe an icon of a box with an “x” inside, and the non-existent icon is intended to indicate that an attribute does not exist and a value for the attribute does not exist in the row where the non-existent icon is shown.

Although the SID heading is not included at the top of a column in FIG. 2, it is included just above the SID value associated with primary key 040. The heading is provided at this location in FIG. 2 to shown that this is the first time in the table that the SID attribute or a value for the SID attribute even exists.

As noted by the non-existent icons in the final column of the rows associated with time t₁, some unknown additional attribute will be provided in this column in association with additional rows during an additional time, even though such attribute does not exist for the rows associated with time t₁.

Data Collected From Time T₂

During time t₂, the operator collected data for three additional wells of “sample” TYPE and one well of “blank” TYPE. The information collected for these wells is provided in the rows of FIG. 2 associated with primary keys 060, 070, 080 and 090. OD values were also collected for each well, along with SID values for the wells of “sample” TYPE. No SID value or attribute is associated with the “blank” TYPE, as the SID value does not exist for a “blank” TYPE well.

In addition to the data mentioned in the preceding paragraph, the data suggests that the operator also decided that it may be beneficial to add an additional attribute for the rows associated with time t₂. In particular, the operator decided that data concerning the volume of the contents in a well could be beneficial to the experimental analysis. Accordingly, the operator added a volume attribute (VOL) and collected data concerning this attribute starting with time t₂. The VOL attribute is shown in the rightmost column of FIG. 2. The heading for this column is provided before the row associated with PK 060, as this attribute did not exist in the data collection of FIG. 2 before this point in time. Because the VOL attribute did not exist during time t₁, all rows associated with time t₁ include a non-existent icon in the rightmost column of the table of FIG. 2.

In the preceding paragraph, the operator decision to collect additional attribute values was the event that ended time period t₁, and started contiguous time period t₂. In particular, when a value for the new attribute VOL was collected, time period t₁ ended and time period t₂ began. However, it should be noted that various other circumstances may trigger the end of one time period and the start of a new time period, such as the occurrence of a particular laboratory event. For example, in the life sciences context, a temperature spike that exceeds a predetermined temperature threshold may signal the system to collect values for a plurality of additional attributes, such as pressure, volume, fluorescence, transmittance, or any number of other attributes. As another example, in the quantum physics context, the detection of a neutrino may trigger the system to obtain values for additional attributes such as radiation, magnetic flux density, as well as numerous other attributes. As used herein, the term “laboratory event” is intended to refer to a determined physical condition in an experimental setting, such as a temperature spike, a concentration gradient, the existence of a particular element, or any other physical condition that may be scientifically determined in an experimental setting.

In addition to the above, it should also be noted that the system need not collect or record a time related to the attributes in the database in order for the attributes to be “associated with” a particular time. As discussed previously, the concept of data being “associated with a particular time” refers to data obtained during the particular time (or time period), or otherwise related to the particular time. Accordingly, an attribute is “associated with a particular time” when a value for the attribute is obtained during the particular time, or the attribute value is assigned for the particular time. An attribute is not associated with a particular time if no value for the attribute is obtained during the particular time, and no attribute value is assigned for the particular time. When an attribute is associated with a particular time, it is not required that the particular time be recorded or otherwise noted in the system.

In the example of FIG. 2, the attributes INDEX, TYPE, OD and SID are associated with time t₁, while the attributes INDEX, TYPE, OD, SID and VOL are associated with time t₂. The time or time periods during which values for these attributes are collected need not be recorded or otherwise noted in the system.

Data Collected From Time T₃

During time t3, the operator collected data for four additional wells of “sample” TYPE. The data collected for these wells is shown in the rows of FIG. 2 associated with PKs 100, 110, 120, and 130. As shown in the data, the operator logged data for the wells associated with these rows for INDEX, TYPE, SID, and VOL. However, the operator decided that it would be unnecessary to collect data for the OD attribute for this time period t3. Accordingly, a non-existent icon is listed in the column of FIG. 2 for the OD attribute in the rows associated with time period t₃.

Once again, the non-existent icons of FIG. 2 are more reflective of the data gathering process, as these icons indicate that this attribute was purposefully omitted from the data in a particular row. Therefore neither this attribute nor a value for the attribute even exists for the data in such a row. This is different from the traditional data populating process where a null value is simply entered for an unknown value.

The above data collection example where differing attributes exist at different times is representative of the data gathering process in many disciplines, including the data gathering process in the field of life sciences. An exemplary representation/visualization of the data collection process is shown in FIG. 2. As shown in the visualization of FIG. 2, the reality of the data collection process is that a resulting table has a jagged edge and/or numerous holes as the result of non-existent attributes. Prior art rectangular visualizations would not include such a jagged edges or holes. In particular, in prior art visualizations, if an attribute is included in one row, it is included in all rows of the tabular visualization and. null values are used when data is unknown or uncollected concerning a particular attribute. This results in a data collection visualization where an attribute is synonymous with a column. Such a visualization does not reflect the reality of many data gathering processes. However, as shown in FIG. 2, with the data collection visualization system and method described herein, an attribute is not synonymous with a column, as certain attributes exist in certain rows but do not exist in other rows. This results in a data collection visualization with jagged edges and/or numerous holes in the visualization as a result of non-existent attributes. Such a data collection visualization better reflects the reality of the data gathering process in fields such as life sciences. Notwithstanding the foregoing, the database system and method disclosed herein also provides the user with the ability to present the data collected in traditional rectangular format in a table having smooth edges and null values in the table, as will be explained in further detail below. Such a rectangular format is usually desirable to many scientists and other database users and operators.

Physical Diagram for Storage of Data

With reference now to FIG. 3, a physical diagram 21 is shown of the table arrangement for retention of the data displayed in FIG. 2. As mentioned previously, the data portion shown in FIG. 2 was collected based on a logical schema which anticipated three entities including a RUNS entity, a LABWARE entity and a WELLS entity. As shown in FIG. 3, the physical diagram for the database schema anticipates at least two tables to describe each entity in the physical database, including an entity table and an entity attributes table for each entity of the logical schema. In particular, the RUNS entity is described by a RUNS table 24 and at least one RUN₁₃ ATTRIBUTES table 34. The LABWARE entity is described by a LABWARE table 26 and a LABWARE_ATTRIBUTES table 36. The WELLS entity is described by a WELLS table 28 and a WELL_ATTRIBUTES table 38. As noted by reference line and circle 25, each run comprises many labware. As noted by reference line and circle 27, each labware comprises many wells. Furthermore, as noted by reference line and circle 33, each run has many run attributes. As noted by reference line and circle 35, each labware has many attributes. As noted by reference line and circle 37, each well has many attributes.

The RUNS table 24 includes a run primary key column (RUN_PK) that specifically and uniquely references each run. The RUNS table 24 may also include one or more additional columns including further data associated with each run/primary key. The RUN_ATTRIBUTES table 34 includes a foreign key column (RUN_FK), an attribute name column (RUN_ATTRNAME) and an attribute value column (RUN_ATTRVALUE). Each run foreign key value associates a row of the RUN_ATTRIBUTES table 34 with a primary key/run of the RUNS table 24. Attribute names for each run are provided in the RUN_ATTRNAME column of the RUN_ATTRIBUTES table 34. Attribute values for the attribute names of each run of the RUN_ATTRIBUTES table 34 are provided in the RUN_ATTRVALUE column.

The LABWARE table 26 includes a labware primary key column (LAB_PK) that specifically and uniquely references each piece of labware. The LABWARE table 26 also includes a run foreign key column (RUN_FK) that associates each row/labware with a run of the RUNS table 24. Furthermore, the LABWARE table 26 may comprise one or more additional columns including further data associated with each piece of labware (e.g., the number of the labware within the run). The LABWARE_ATTRIBUTES table 36 includes a labware foreign key column (LAB_FK), a labware attribute name column (LAB_ATTRNAME), and a labware attribute value column (LAB_ATTRVALUE). Each labware foreign key value associates a row of the LABWARE_ATTRIBUTES table 36 with a row/primary key of the LABWARE table 26. Attribute names for each piece of labware are provided in the LAB_ATTRNAME column of the LABWARE_ATTRIBUTES table 36. Attribute values for the attribute names in each row of the LABWARE_ATTRIBUTES table 36 are provided in the LAB_ATTRVALUE column.

The WELLS table 28 includes a well primary key column (WELL_PK) that specifically and uniquely references each well. The WELLS table 28 also includes a labware foreign key column (LAB_FK) that associates each row/well with a labware of the LABWARE table 26. A well index column (WELL_INDEX) is also provided to identify the well number within a particular labware (e.g., 1 . . . 96 for a 96 well microplate). Furthermore, the WELLS table 28 may comprise one or more additional columns including further data associated with each well. The WELL_ATTRIBUTES table 38 includes a well foreign key column (WELL_FK), a well attribute name column (WELL_ATTRNAME), and a well attribute value column (WELL_ATTRVALUE). Each well foreign key value associates a row of the WELL_ATTRIBUTES table 36 with a row/primary key of the WELLS table 36. Attribute names for each well are provided in the WELL_ATTRNAME column of the WELL_ATTRIBUTES table 38. Attribute values for the attribute names in each row of the WELL_ATTRIBUTES table 38 are provided in the WELL_ATTRVALUE column.

Entity Table

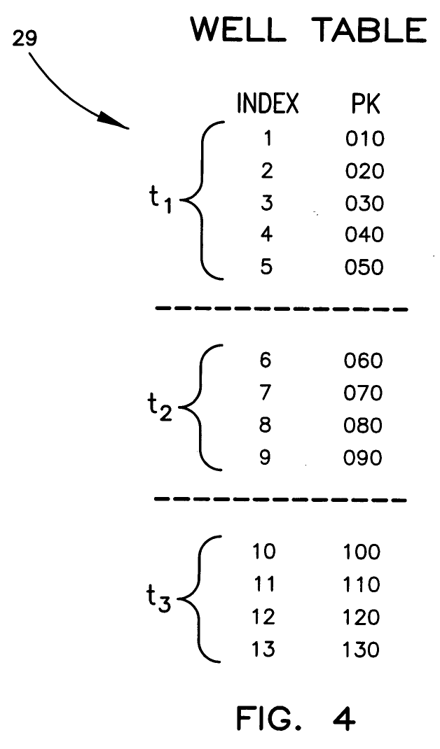

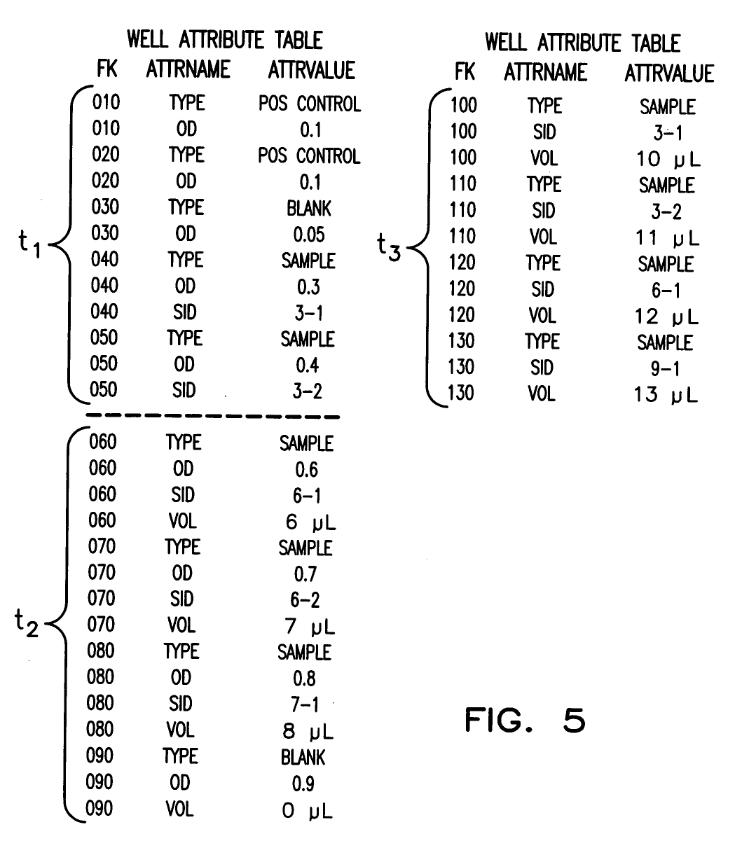

The data collection of FIG. 2 will now be described with reference to the physical diagram of FIG. 3. In particular, the data collection of FIG. 2 may be managed by one of the WELLS tables 28 and one of the WELL_ATTRIBUTES tables 38 of FIG. 3. A detailed view of a WELL table 29 is shown in FIG. 4 and a detailed view of a WELL_ATTRIBUTES table 39 is shown in FIG. 5.

With reference to FIG. 4, the WELLS table 29 includes two columns and numerous rows. The columns include an index column (INDEX) and a primary key column (PK). Although a foreign key column is not shown in FIG. 4, a foreign key column (e.g., LAB_FK, as shown in FIG. 3) could be used to associate each row of the WELL table 29 to a row of one of the LABWARE tables 26 according to the schema presented herein.

The thirteen rows shown in the WELL table 29 of FIG. 4 display the INDEX values and PK values from the data of FIG. 2. Brackets are shown in association with the rows to indicate that the data in these rows is associated with a particular time. While these brackets are not intended to imply that the table includes attribute values or other data showing that the data in the row is associated with particular time periods, the brackets are intended to serve as a visual indication to the reader that the data in the row is associated with a particular time, as described above with reference to FIG. 2.

The values in the INDEX column of the WELLS table 29 of FIG. 4 identify specific wells of a particular piece of labware (e.g., wells 1 to 96 for a 96 well microplate). Although a foreign key value is not shown for each row, a foreign key value would be used to associate each row with a particular piece of labware from the LABWARE table 26 of FIG. 3. The values in the PK column of the WELLS table 29 of FIG. 3 provide the primary keys for identifying each row in the WELLS table 29.

Entity Attribute Table

With reference to FIG. 5, the WELL_ATTRIBUTES table 39 includes three columns and numerous rows. The columns include a foreign key column (FK), an attribute name column (ATTRNAME), and an attribute value column (ATTRVALUE).

The FK column is the first column of the WELL_ATTRIBUTES table 39. Each foreign key value in the FK column of the WELL_ATTRIBUTES table 39 identifies a PK value in the WELLS table 29. As a result, each row of the WELL_ATTRIBUTES table 39 of FIG. 5 is associated with a row of the WELLS table 29 of FIG. 4. For example, the first two rows of FIG. 5 show a value of “010” in the FK column. This FK value of “010” associates this data with the row of the WELLS table 29 having an identical PK value of “010”. Thus, the data in the first two rows of the WELL_ATTRIBUTES table 39 of FIG. 5 is associated with the first row of the WELLS table 29 of FIG. 4. The first row of the WELLS table 29 identifies data for the first well of the particular piece of labware as noted in FIG. 4 by the INDEX value associated with PK value “010”.

The second column of the WELL_ATTRIBUTES table of FIG. 5 identifies the name of a particular entity attribute. For example, the TYPE attribute is the WELLS entity attribute identified in the first row of the ATTRNAME column. This TYPE attribute is one of the attributes identified in the collection of data shown in FIG. 2. The second row of the ATTRNAME column identifies a different attribute for the WELLS entity. In particular, the second row of the ATTRNAME column identifies the OD attribute (i.e., optical density attribute).

The third column of the WELL_ATTRIBUTES table 39 of FIG. 5 provides a value for the particular attribute named in the second column of the table 39. For example, the value of “pos control” is provided in the first row of the ATTRVALUE column. Thus, “pos control” is the value for the TYPE attribute named in column two. Similarly, the value of “0.1” is provided in the second row of the ATTRVALUE column. Thus, “0.1” is the value for the OD attribute named in column two. Of course, as described previously, using the foreign key of each row, this data is easily associated with the first well of the particular piece of labware identified in the WELLS table 29 of FIG. 4. In one embodiment, the WELL_ATTRIBUTES table 39 may also include an attribute type column. This column could be used to identify the domain to which individual values in the ATTRVALUE column belong. For example, the attribute type could be a “string”, “floating point”, “integer”, or other domain type commonly used in databases. Such an attribute type identifier could be useful to the database in performing various database operations, such as arithmetic operations.

All of the data displayed in FIG. 2 has been translated into the two tables shown in FIGS. 4 and 5 in the manner described above. As discussed previously, the data of FIG. 2 includes different numbers of attributes in different rows (i.e., different attributes existed for different wells at different times). Therefore, it should be noted that the number of rows having the same foreign key in the WELL_ATTRIBUTES table 39 of FIG. 5 will vary based on the number of attributes that exist for a particular well. Thus, if a row of data in FIG. 2 included two attributes in addition to the primary key and INDEX attribute (which are shown in the WELLS table 29 of FIG. 4), only two rows of data are required in the WELL_ATTRIBUTES table 39 of FIG. 5 to represent the two attributes and values for the two attributes. However, if three attributes existed in addition to the primary key and INDEX attribute for a particular well represented in FIG. 2, three rows are required in the WELL_ATTRIBUTES table 39 of FIG. 5 to represent the attributes and values for the attributes. For example, only two attributes (i.e., TYPE and OD) existed in FIG. 2 for INDEX “1”. Thus, two rows exist in the WELL_ATTRIBUTES table 39 of FIG. 5 with the foreign key “010” which is associated with INDEX “1” in the WELLS table 29 of FIG. 4. However, three attributes (i.e., TYPE, OD, and SID) existed in FIG. 2 for INDEX “4”. Thus, three rows exist in the WELL_ATTRIBUTES table 39 of FIG. 5 with the foreign key “040” which is associated with INDEX “4” in the WELLS table 29 of FIG. 4.

Based on the description above, it can be seen that the database described herein is configured to provide an entity table (e.g., table 29) and an entity attributes table (e.g., table 39) for each entity of a logical schema. The entity table comprises a plurality of rows with each row including a primary key. The entity attributes table comprises a plurality of rows with each row including a foreign key, at least one attribute name, and at least one attribute value associated with the attribute name (i.e., a foreign key column, an attribute name column, and an attribute value column). Thus, each row of the entity attributes table includes a plurality of attribute-name/attribute-value pairs for the entity with at least one attribute-name/attribute-value pair stored in each row of the table.

As also illustrated from the description above, the plurality of rows of the entity attributes table comprise a first set of rows having a first common foreign key associated with one of the primary keys of the entity table. The plurality of rows of the entity attributes table further comprise a second set of rows having a second common foreign key associated with a different primary key of the entity table, wherein the number of rows in the first set of rows is different from the number of rows in the second set of rows. This arrangement provides for a database wherein the attributes associated with a particular entity may be varied. Attributes may vary based on the applicability of the attribute to a particular collection of data. Alternatively, attributes may vary from time to time based upon the wishes of the scientist or other database user.

Clustered Index

In one embodiment, the data contained in the WELL_ATTRIBUTES table 39 of FIG. 5 is indexed on the foreign key (FK). The index is a clustered index which is well known in the art. The clustered index provides for contiguous storage of the data associated with the foreign key on the storage medium (e.g., the hard disk). In particular, the clustered index guarantees that a given set of attributes are physically contiguous on the hard disk. The use of the clustered index leads to significant performance benefits. For example, use of the clustered index allows SQL searches of the database to be performed at a faster speed than would be possible with a non-clustered index.

The WELLS table 29 of FIG. 4 may also be indexed. For example, the WELLS table may be indexed on the primary key (PK). Like the index on the WELL_ATTRIBUTES table, the index of the WELLS table may be a clustered index.

Pivot Operation

Data stored in the database described herein may be presented to the user in a rectangular format, such as a standard spreadsheet. In order to present the data in a rectangular form, the user performs a “pivot” operation as is well known in the art. The pivot operation is performed using an SQL statement or statements. When executed, the “pivot” operation can manipulate selected data from one or more tables into a new table for presentation to the user. The form of the new table is determined by the user.

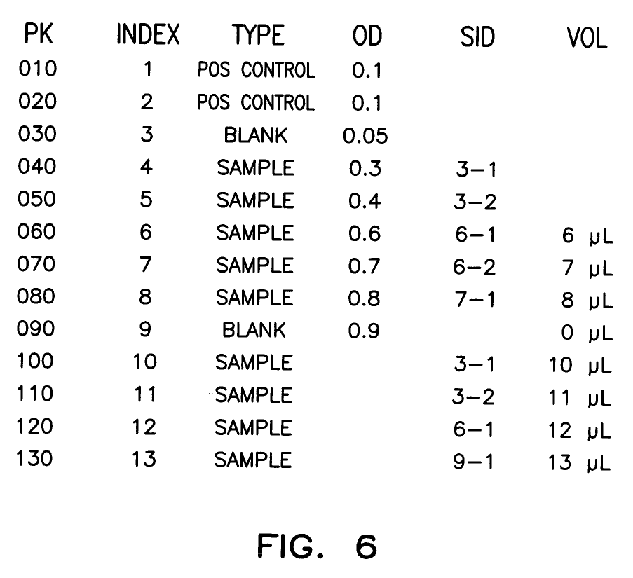

FIG. 6 shows an example of what the data from FIGS. 4 and 5 might look like following a “pivot” operation. It will be noted that the data presented in the table of FIG. 6 is similar to the data in the table of FIG. 2. However, unlike the table of FIG. 2, the table of FIG. 6 is rectangular with smooth edges and does not include any holes in the table (such as those represented by non-existent icons in FIG. 2).

The attribute names from the WELL_ATTRIBUTES table 39 of FIG. 5 are listed as column headings in the rectangular table of FIG. 6. In particular, time t₁ includes a first set of attribute names (i.e., TYPE, OD, and SID), time t₂ includes a second set of attribute names (i.e., TYPE, OD, SID and VOL), and time t₃ includes a third set of attribute names (i.e., TYPE, SID and VOL). The attribute names from the union of these sets of attribute names (i.e., TYPE, OD, SID and VOL) are provided as column headings in FIG. 6. If an attribute does not exist for a particular row and column of the table of FIG. 6, a null value is shown by a blank in that row for the attribute. Although the user is presented with a null or blank value in this situation, the user can view the underlying tables (e.g., the WELLS table 29 or WELL_ATTRIBUTES table 39) to determine whether, (i) the attribute exists for the row but the value is unknown, or (ii) the attribute does not even exist for the row.

It should be noted again that the information presented in FIG. 2 is a tabular visualization of the data that actually exists in the database. By contrast, FIG. 6 is a representation of the data in the database (i.e., the data of FIG. 2) in a rectangular format. The rectangular format of FIG. 6 is a preferred format for operators, scientists, and other users of databases, as the standard rectangular table is well known and understood. However, as discussed above, the blanks in rectangular tables as representative of null values often does not reflect the reality of the data gathering process. The database system and method described herein more closely represents the actual data gathering process. The act of pivoting the data in the database described herein is a useful tool that allows the data in the database to be communicated to the user in a traditional manner, if desired.

Exemplary Operator Interface

The database described above is configured for use with an operator interface presented on a display screen. The operator interface is designed allow a user to control an automated laboratory testing apparatus (not shown) and store collected data in the database.

The automated laboratory testing apparatus is configured to process various test samples according to various user defined experimental steps. As the experimental steps are carried out, the automated laboratory apparatus obtains various measurements related to the samples. The measurements obtained are values that are associated with various attributes in the database. In one embodiment, the automated laboratory testing apparatus may be configured to unconditionally obtain values for a plurality of predetermined attributes, and store such values in the database, for each and every set defined experimental steps.

In cooperation with the database described above, the operator interface is configured to allow the user to dynamically select a plurality of attributes to be associated with a given experimental entity. For example, the operator interface is configured to allow the user to dynamically select attributes for the RUNS entity of the logical schema of FIG. 1. In the event the automated laboratory testing apparatus is configured to unconditionally obtain values for a plurality of predetermined attributes for each and every set of experimental steps, the user may add additional attributes for a given series of experimental steps. Subsequently, the user may remove one or more of the additional attributes from the series of experimental steps.

In addition to the above, the user interface is configured to allow the user to create tabular reports of the data in the database. These tabular reports may include data from one or more tables in the database. A spreadsheet software program may be used to provide such reports, such as the EXCEL® spreadsheet from Microsoft Corporation.

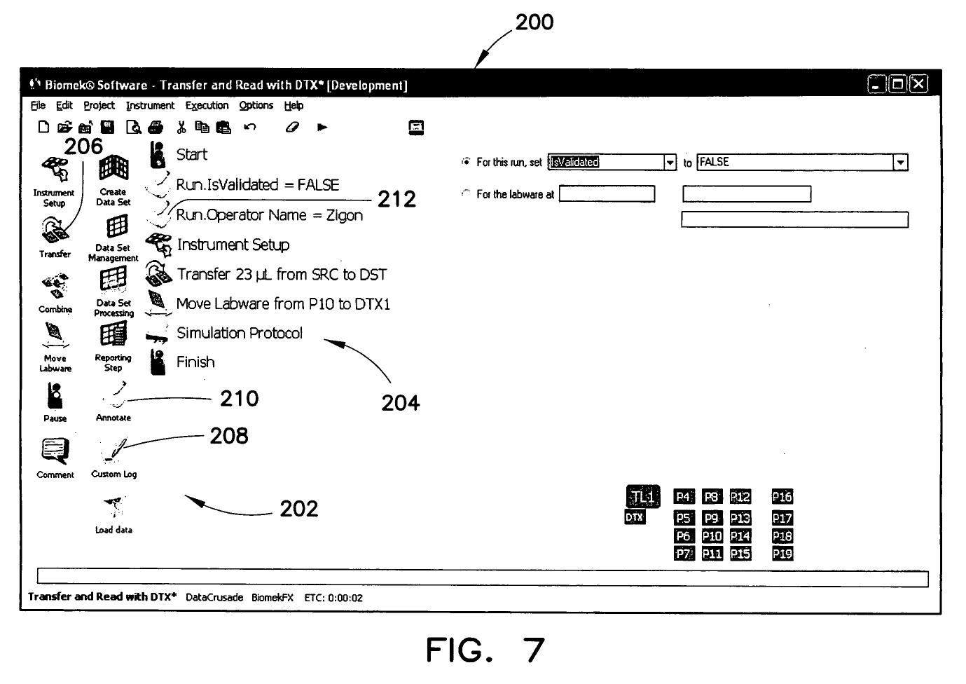

An exemplary user interface is shown with reference to FIGS. 7-9. As shown in FIG. 7, the user is presented with a set of icons 202 on the left side of the screen. On the right side of the screen is a list of experimental steps 204 to be performed. Each icon 202 on the left side of the screen represents a step or series of steps that may be performed during a particular experimental method. For example, a given icon may instruct an instrument to perform a task, such as icon 206 which may be used to instruct the automated instrument to transfer liquid from one location to another. Alternatively, a given step may be used to perform some administrative or data related function, such as icon 208 which is used to create a custom data log for the user.

As shown in FIG. 7, the set of icons 202 also includes an annotate icon 210 used to add new attributes to the experimental method. New attributes added with the annotate icon 210 are attributes in addition to the predefined set of attributes automatically collected by the automated laboratory instrument for each set of experimental steps. In order to add an attribute to the list of experimental steps 204, the user clicks the annotate icon 210 and drags the icon to the list of experimental steps 204. The user then enters an attribute name and an attribute value to be associated with the attribute. For example, at location 212 in FIG. 7, the user entered the annotate icon 21 and defined the new attribute “Run.Operator Name”. The value for the attribute “Run.Operator Name” for this particular run is “Zigon”. In addition, at location 214 in the list of experimental steps 204, the user added the new attribute “Run.IsValidated”. The user set this value to “FALSE” for this particular experimental run.

Once a new attribute associated with a particular set of defined experimental steps the attribute remains with the set of experimental steps until the user decides to delete the attribute. For example, assume that for a subsequent run using the same set of defined experimental steps, a user decides that the attribute “Run.Operator Name” is no longer needed. In this case, the user would simply click on the icon next to the attribute “Run.Operator Name” at location 212 in the list of steps 204 and drag the icon back to the left side of the screen 202. This action deletes the attribute from this and subsequent runs using this set of experimental steps, unless the attribute is added again at a later time.

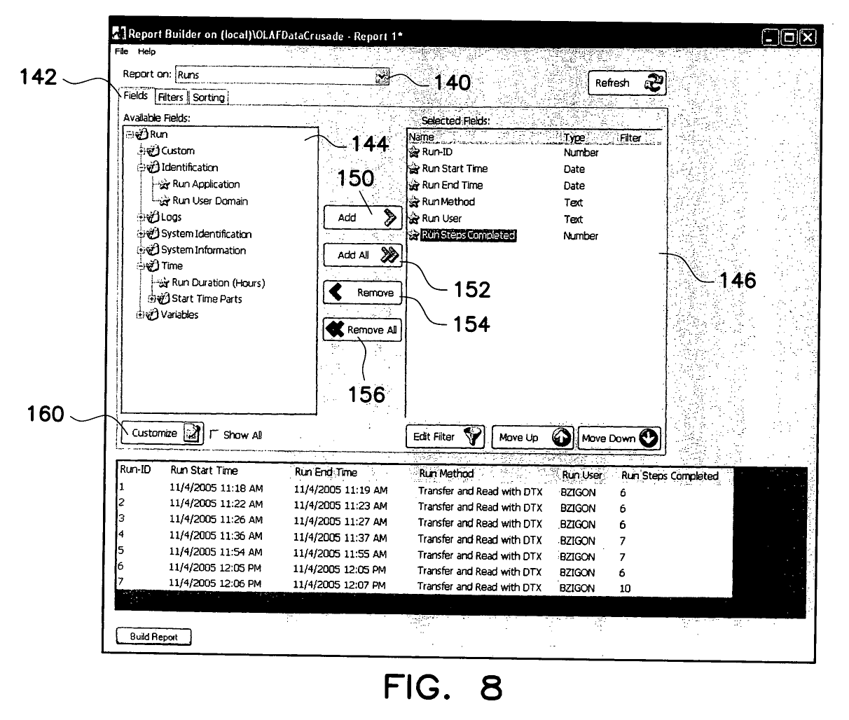

After running the series of steps as shown in FIG. 7, the user may build a report to show the results of the experimental run. An exemplary screen for creating a report is shown in FIG. 8. As shown in FIG. 8, the user first selects an entity for which he or she wishes to obtain a report. This selection may be made from the “Report on”drop down menu 140 in FIG. 8. In addition to the “Runs” entity shown in FIG. 7, the drop down menu also lists the “Labware” and “Wells” entities as described in association with the logical schema of FIG. 1. Of course, the database system described herein is not limited to a particular database schema, and the entities listed in the drop down menu 140 depend upon the entities of the logical schema of the database.

After selecting the entity for the desired report, the user clicks on the “Fields” tab 142. After the “Fields” tab 142 is clicked, a box 144 is presented to the user of available database fields (i.e., attributes) that have been collected for the entity. The user then selects one of the attributes and clicks on the “Add” button 150 to move the selected attribute into the “Selected Fields” box 146. The “Selected Fields” box 146 lists all attributes for which data will be provided in a report. The attributes in the “Selected Fields” box 146 are the union of all attributes collected for the entity at any time. The attributes from the “Available Fields” box 144 may be added to the “Selected Fields” box by clicking the “Add All” button 152. If the user wishes to remove any attributes from the “Selected Fields” box 146, the user clicks the remove button 154. All attributes may be removed from the “Selected Fields” box by clicking on the “Remove All” button 156.

The user also has the option of selecting which data will be shown in the report. For example, by clicking on the “filters” tab 143, the user may filter information from the report that is not related to runs one through ten. Of course, if desired, the user may obtain a report that includes information for all runs, labware or wells.

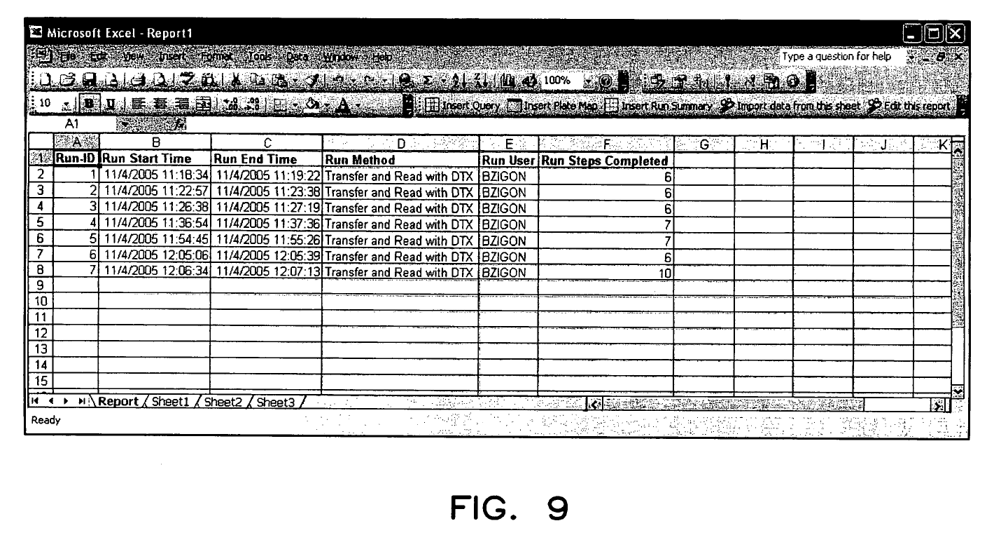

FIG. 9 shows an exemplary spreadsheet report of the data requested in FIG. 8. Each attribute requested is listed at the top of each column of the table. Each row of the table provides values for a particular entity record. For example, as shown in FIG. 9, the report provides information concerning seven different experimental runs. Information is provided in each row for the Run Start Time, Run End Time, Run Method, Run User, and Run Steps Completed attributes. If any of these attributes differed from one run to the next run, a null value would be shown in the column of the row for which the attribute did not exist, similar to the null values shown in FIG. 6. However, in the exemplary report shown in FIG. 9, all attributes existed for all rows, so no null values are required.

Although the present invention has been described with respect to certain preferred embodiments, it will be appreciated by those of skill in the art that other implementations and adaptations are possible. For example, although the database system and method has been described herein with respect to a specific application in the field of life sciences, the database system and method could be used in numerous other applications in the life sciences or other unrelated fields. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A method of storing data in a database, the database having a database schema with referential integrity, and the database schema including a plurality of entities associated with a plurality of attributes, the method comprising:
a) populating a table of the database with values associated with the plurality of attributes; and
b) varying the plurality of attributes in the table of the database over time such that the table of the database includes a first set of attributes associated with a first time and a second set of attributes associated with a second time, the first time being different from the second time, wherein the second set of attributes includes at least one attribute that is included in the first set of attributes and at least one attribute that is not included in the first set of attributes, and wherein the referential integrity of the database is maintained as the plurality of attributes in the table of the database are varied.

2. The method of claim 1 further comprising the step of pivoting the data in the database such that the data in the table of the database is displayed in a rectangular format.

3. The method of claim 2 wherein the step of pivoting results in a rectangular display including a plurality of column headings, wherein each column heading references one of the attributes from the union of the first set of attributes and the second set of attributes.

4. The method of claim 3 wherein the rectangular display includes a first plurality of rows associated with the first time and a second plurality of rows associated with the second time.

5. The method of claim 4 wherein a null value is provided in the rectangular display in each row of the first plurality of rows associated with the first time in the column having a column heading for the at least one attribute that is not included in the first set of attributes.

6. The method of claim 5 wherein the null value is shown as a blank in the rectangular display.

7. The method of claim 1 wherein the database further includes a third set of attributes associated with a third time, wherein the third set of attributes includes at least one attribute that is not included in the first set of attributes or the second set of attributes, and wherein the third set of attributes does not include at least one attribute that is included in the first set of attributes and the second set of attributes.

8. The method of claim 1 wherein the database is a relational database.

9. The method of claim 1 wherein the second time is triggered by the occurrence of a laboratory event.

10. A database having a database schema with referential integrity, the database schema defining a plurality of entities and a plurality of attributes, the database comprising:
a) at least one entity table comprising a plurality of rows, the plurality of rows of the at least one entity table including a first row associated with a first time and a second row associated with a second time that is different from the first time; and
b) at least one entity attribute table comprising a plurality of rows, each row of the entity attribute table including an attribute name and an attribute value associated with the attribute name, the plurality of rows of the entity attribute table comprising a first set of rows and a second set of rows, wherein each row of the first set of rows of the entity attribute table is associated with the first time, and each row of the second set of rows of the entity attribute table is associated with the second time, and wherein the attribute names in the second set of rows include at least one attribute name not found in the first set of rows.

11. The database of claim 10 wherein the attribute names in the first set of rows include at least one attribute name not found in the second set of rows.

12. The database of claim 10 wherein the entity attribute table includes a foreign key column and each row of the entity attribute table comprises a foreign key value.

13. The database of claim 12 wherein each row of the entity table includes one of a plurality of primary key values, and wherein each foreign key value from the entity attribute table references one of the primary key values of the entity table.

14. The database of claim 12 wherein the database includes an index on the foreign key column of the entity attribute table.

15. The database of claim 14 wherein the index is a clustered index.

16. A method of storing data in a database, the database having a database schema with referential integrity, the database schema defining a plurality of tables, the method comprising:
a) populating an entity table with data, the entity table including a plurality of rows, each of the plurality of rows of the entity table including a primary key value;
b) populating an entity attribute table with data, the entity table including a plurality of rows, each of the plurality of rows of the entity attribute table including a foreign key value, an attribute name and an attribute value; wherein the plurality of rows of the entity attribute table comprise a first set of rows having a common first foreign key value and a second set of rows having a common second foreign key value different than the first foreign key value, wherein the number of rows in the first set of rows is different than the number of rows in the second set of rows.

17. The method of claim 16 wherein at least two attribute names from the first set of rows are identical to at least two attribute names from the second set of rows.

18. The method of claim 16 wherein the number of attribute names in the first set of rows is greater than the number of attribute names in the second set of rows.

19. The method of claim 16 wherein the number of attribute names in the first set of rows is less than the number of attribute names in the second set of rows.

20. The method of claim 16 further comprising the step of pivoting the data in the entity attribute table such that the data is displayed in a rectangular table with attribute names presented as column headings.

21. A database including a plurality of tables, the database comprising:
a) at least one entity table comprising a plurality of rows, wherein each of the plurality of rows of the entity table includes a primary key value such that a first row of the entity table includes a first primary key value and a second row of the entity table includes a second primary key value; and
b) at least one entity attribute table comprising a plurality of rows, each row of the entity attribute table including a foreign key value, at least one attribute name, and at least one attribute value associated with the attribute name; wherein the plurality of rows of the entity attribute table comprise (i) a first set of rows having a first common foreign key value associated with the first primary key value of the entity table, and (ii) a second set of rows having a second common foreign key value associated with the second primary key value of the entity table, wherein the number of rows in the first set of rows is different from the number of rows in the second set of rows.

22. The database of claim 21 wherein data in the first set of rows is associated with a first period of time and data in the second set of rows is associated with a second period of time that is different from the first period of time.

23. The database of claim 21 wherein the attribute value in each row of the entity attribute table is associated with one of a plurality of wells of a microplate by the foreign key value.

24. A method of managing data within a database, the database having a database schema with referential integrity, and the database schema including a plurality of entities associated with a plurality of attributes, the method comprising:
a) collecting a first set of data including a first set of attribute names and an attribute value associated with each attribute of the first set of attribute names;
b) collecting a second set of data including a second set of attribute names and an attribute value associated with each of the second set of attribute names, wherein the second set of attribute names includes at least one attribute name not included in the first set of attribute names;
c) storing the first set of data and the second set of data in a database table; and
d) pivoting the database table into a rectangular display table, the display table including a plurality of column headings, the plurality of column headings including the union of the first set of attribute names and the second set of attribute names.

25. The method of claim 24 wherein the first set of data is associated with a first time and the second set of data is associated with a second time different from the first time.

26. The method of claim 24 wherein the database table is an entity attribute table with each row of the entity attribute table comprising an attribute-name/attribute-value pair.

27. The method of claim 24 wherein a null value is inserted in the display table in a row of the display table related to the first set of data at a column associated with the at least one attribute name not included in the first set of attribute names.

28. The method of claim 27 wherein the null value is displayed by a blank.

29. The method of claim 24 wherein each row of the database table comprises a foreign key value, and the database table is indexed by the foreign key values.

30. The method of claim 29 wherein the database table is indexed using a clustered index.

31. A method of storing data in a database, the database having a database schema with referential integrity, and the database schema including a plurality of entities associated with a plurality of attributes, the method comprising:
a) populating a table of the database with values associated with the plurality of attributes; and
b) varying the plurality of attributes in the table of the database based upon the occurrence of a laboratory event such that the table includes a first set of attributes included in a first set of rows containing data collected prior to the occurrence of the laboratory event and a second set of attributes included in a second set of rows containing data collected following the occurrence of the laboratory event, wherein the second set of attributes includes at least one attribute that is included in the first set of attributes and at least one attribute that is not included in the first set of attributes, and wherein the referential integrity of the database is maintained as the plurality of attributes in the table of the database are varied.

32. The method of claim 31 wherein the laboratory event is the detection of a predetermined temperature.

33. The method of claim 31 further comprising the step of further varying the plurality of attributes in the table of the database based upon the occurrence of a subsequent laboratory event such that the table includes a third set of attributes in a third set of rows containing data collected following the occurrence of the subsequent laboratory event, wherein the second set of attributes includes at least one attribute that is included in the third set of attributes and at least one attribute that is not included in the third set of attributes.
